(19) United States
(12) Patent Application Publication
(10) Pub. No.: US 2026/0106281 A1
(43) Pub. Date: Apr. 16, 2026

(54) RECHARGEABLE BATTERY AND BATTERY PACK INCLUDING THE SAME

(71) Applicant: SAMSUNG SDI CO., LTD., Yongin-si (KR)

(72) Inventor: Sang Hun KIM, Suwon-si (KR)

(21) Appl. No.: 19/350,883

(22) Filed: Oct. 6, 2025

(30) Foreign Application Priority Data
Oct. 14, 2024 (KR) 10-2024-0139712
Sep. 30, 2025 (KR) 10-2025-0142985

(51) Int. Cl. H01M 50/169; H01M 10/0525; H01M 50/103; H01M 50/119; H01M 50/133; H01M 50/15

(52) U.S. Cl. CPC H01M 50/169; H01M 10/0525; H01M 50/103; H01M 50/119; H01M 50/133; H01M 50/15

(57) ABSTRACT

A rechargeable battery and a battery pack including the same are disclosed. A rechargeable battery includes a case including a first side portion, an electrode assembly accommodated in the case, and a cap plate facing the electrode assembly in a first direction and having a contact region in contact with the first side portion, and the contact region includes a bonded region and a non-bonded region between the first side portion and the cap plate, and an adhesive portion is in at least a portion of a first region of the first side portion corresponding to the non-bonded region.

### CROSS-REFERENCE TO RELATED APPLICATION

The present application claims priority to and the benefit of Korean Patent Application No. 10-2024-0139712, filed on Oct. 14, 2024 in the Korean Intellectual Property Office, and Korean Patent Application No. 10-2025-0142985, filed on Sep. 30, 2025 in the Korean Intellectual Property Office, the entire disclosures of both of which are incorporated herein by reference.

### BACKGROUND

### 1. Field

Aspects of embodiments of the present disclosure relate to a rechargeable battery and a battery pack including the same.

### 2. Description of the Related Art

In general, with the rapid spread of electronic devices that use batteries, such as portable phones, laptop computers, and electric vehicles, the demand for high energy density and high-capacity rechargeable batteries is rapidly increasing. Accordingly, research and development to improve the performance of lithium rechargeable batteries is actively being conducted.

A lithium rechargeable battery is a battery that includes a positive electrode and a negative electrode including active materials capable of intercalation and deintercalation of lithium ions, and an electrolyte, and produces electrical energy through oxidation and reduction reactions when lithium ions are intercalated/deintercalated into/from the positive electrode and negative electrode.

The above-described information disclosed in the background technology of this invention is provided for understanding of the background of the present invention and may include information that does not constitute related art.

### SUMMARY

According to an aspect of one or more embodiments of the present invention, a battery capable of preventing (preventing or substantially preventing) fractures in a side portion of a case during charging and discharging of the battery, and a battery pack including the same, are provided.

However, aspects and technical problems to be solved by the present invention are not limited to the aspects and problems to be solved described above, and other aspects and problems to be solved not mentioned can be clearly understood by those skilled in the art from the description of the invention described below.

According to one or more embodiments of the present invention, a rechargeable battery includes a case including a first side portion, an electrode assembly accommodated in the case, and a cap plate facing the electrode assembly in a first direction, and including a contact region which contacts the first side portion, wherein the contact region includes a bonded region between the first side portion and the cap plate; and a non-bonded region, and an adhesive portion is in at least a portion of a first region of the first side portion corresponding to the non-bonded region.

According to embodiments of the present invention, fractures in a side portion of a case during charging and discharging of a battery can be prevented (prevented or substantially prevented), thereby increasing the reliability of a rechargeable battery.

However, aspects and effects obtained through the present invention are not limited to the above-described aspects and effects, and other aspects and technical effects that are not mentioned will be clearly understood by those skilled in the art from the description of the invention described below.

### BRIEF DESCRIPTION OF THE DRAWINGS

The following drawings attached to the present specification illustrate some embodiments of the present disclosure and further describe aspects and features of the present disclosure together with the detailed description of the present disclosure. However, the present disclosure is not to be construed as being limited to the drawings, in which:

FIG. 1 is an exploded perspective view schematically illustrating a configuration of a battery pack according to an embodiment of the present invention;

FIG. 2 is a perspective view schematically illustrating a configuration of a rechargeable battery according to an embodiment of the present invention;

FIG. 3 is an exploded perspective view schematically illustrating a configuration of the rechargeable battery according to an embodiment of the present invention;

FIG. 4 is an explanatory view of an operation of a first side portion of the case and a cap plate during charging and discharging of the rechargeable battery;

FIG. 5 is an enlarged view illustrating a configuration of the first side portion of the case and the cap plate of the rechargeable battery according to an embodiment of the present invention;

FIG. 6 is an enlarged view illustrating a configuration of a first side portion of a case and a cap plate of a rechargeable battery according to another embodiment of the present invention;

FIG. 7 is an explanatory view of an attachment shape of an adhesive portion on a first side portion of a rechargeable battery according to another embodiment of the present invention; and

FIG. 8 is an explanatory view of an attachment shape of an adhesive portion on a first side portion of a rechargeable battery according to another embodiment of the present invention.

### DETAILED DESCRIPTION

Herein, some embodiments of the present invention will be described in further detail with reference to the attached drawings. Terms or words used in this specification and claims are not to be interpreted as being limited to ordinary or dictionary meanings and are to be interpreted as having meanings and concepts consistent with the technical idea of this invention based on the principle that the inventor can properly define the concept of the term in order to describe his or her invention in the best way. Accordingly, it is to be understood that the embodiments described herein, and the configurations illustrated in the drawings are only some embodiments of the invention and do not necessarily represent all of the technical ideas of the invention, and that there may be various equivalents and modifications that may replace them at the time of filing.

Further, when used herein, the terms “comprise” or “include” and/or “comprising” or “including” specify the presence of the mentioned shapes, numbers, steps, operations, members, elements, and/or groups thereof, but are not intended to exclude the presence or addition of one or more other shapes, numbers, operations, members, elements, and/or groups thereof.

In addition, to facilitate understanding of the invention, the attached drawings may not be drawn to actual scale, and the dimensions of some components may be exaggerated. In addition, the same reference numbers may be assigned to the same components in different embodiments.

The statement that two objects for comparison are “equal” means equal, the same, or substantially the same. Therefore, equal, the same, or substantially the same may include deviations that are considered low in the art, for example, deviations of less than 5%. Additionally, uniformity of a parameter over a given region may imply uniformity from an average perspective.

Although “first,” “second,” and the like are used to describe various components, the components are not limited by these terms. These terms are used to distinguish one component from another, and, unless otherwise specifically stated, it is to be understood that a first component may also be a second component.

Throughout the specification, unless otherwise specifically stated, each element may be singular or plural.

When any component is disposed “on (or under)” a component or “above (or below)” a component, it may mean not only that any component is disposed in contact with the component, but also that another component may be interposed between the component and any component disposed on (or under) the component.

In addition, when a component is described as being “on,” “connected to,” or “coupled to” in another component, the above components may be directly connected or coupled to each other, but it is to be understood that one or more other components may be “interposed” between each component, or each component may be “connected,”“coupled,”or “linked”through another component.

As used herein, the term “and/or” includes any and all combinations of one or more of the associated listed items. Further, the use of “may” when describing embodiments of the present disclosure relates to “one or more embodiments of the present disclosure.”. Equations such as “one or more” and “one or more” before the list of elements modify the entire list of elements and do not modify individual elements in the list.

Throughout the specification, “A and/or B” means A, B, or A and B unless otherwise stated to the contrary. That is, “and/or” includes any or all combinations of a plurality of listed items. When “C to D” is stated, it means greater than or equal to C and less than or equal to D unless otherwise specifically stated.

When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C.

The term “use” may be considered synonymous with the term “utilize.” As used herein, the terms “substantially,” “about,” and similar terms are used as terms of approximation, not as terms of degree, and are intended to take into account inherent variations in measured or calculated values that would be recognized by a person of ordinary skill in the art.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be named a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the drawings. It is to be understood that the spatially relative terms are intended to encompass different orientations of the device in use or operation in addition to the orientation depicted in the drawings. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to limit the present disclosure.

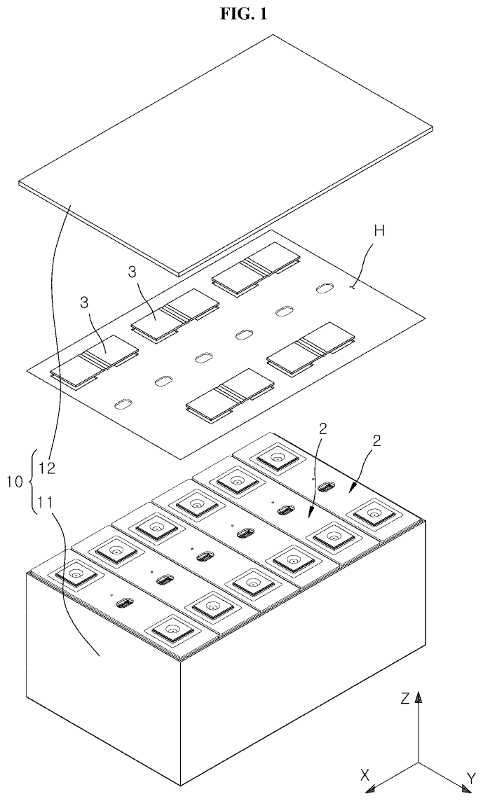

FIG. 1 is an exploded perspective view schematically illustrating a configuration of a battery pack according to an embodiment of the present invention.

Referring to FIG. 1, a battery pack according to an embodiment may include a housing 10, a rechargeable battery 2, and a busbar 3.

The housing 10 may generally form an exterior of the battery pack and provide a space in which the rechargeable battery 2 may be accommodated.

The housing 10 according to an embodiment may include a housing body 11 and a cover 12.

The housing body 11 may be formed to have a shape of a box with an empty interior and an open side. However, a cross-sectional shape of the housing body 11 is not limited to a quadrangular shape, as illustrated in FIG. 1, and may have any of various shapes, such as polygonal, circular, oval, or other shapes.

The cover 12 may be coupled to the housing body 11 and may close an internal space of the housing body 11. In an example, the cover 12 may have a generally plate shape and may be disposed to face the open side of the housing body 11. The cover 12 may be fixed to the housing body 11 by any of various types of coupling methods, such as bolting, welding, fitting, etc.

The rechargeable battery 2 may function as a unit structure for storing and supplying power in the battery pack.

Herein, the rechargeable battery 2 according to one or more embodiments of the present invention will be described.

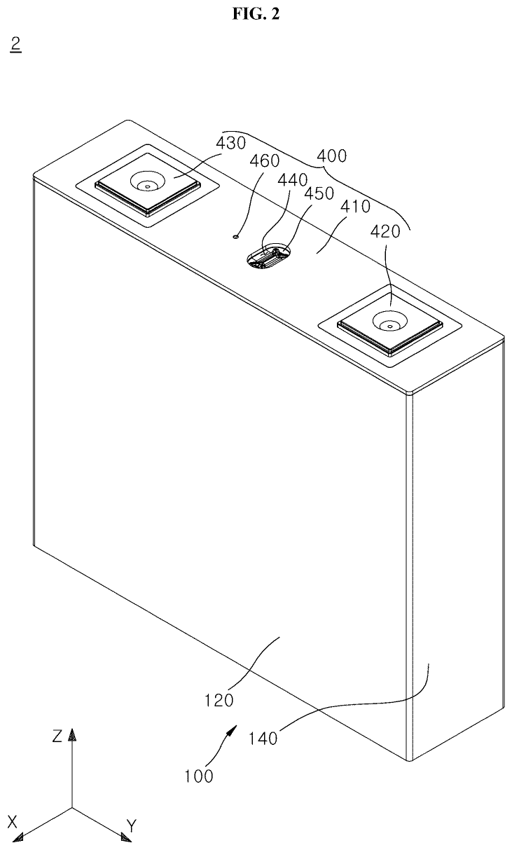

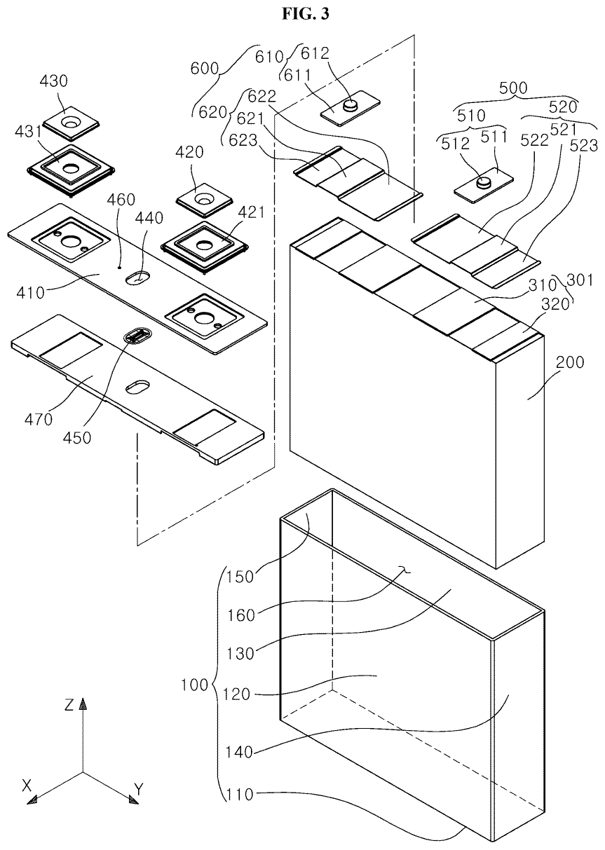

FIG. 2 is a perspective view schematically illustrating a configuration of a rechargeable battery according to an embodiment of the present invention; and FIG. 3 is an exploded perspective view schematically illustrating a configuration of the rechargeable battery according to an embodiment of the present invention.

Herein, an example in which the rechargeable battery 2 is a prismatic battery as a lithium ion rechargeable battery will be described. However, the present invention is not limited thereto, and the rechargeable battery may be a lithium polymer battery or a cylindrical battery, for example.

Referring to FIGS. 2 and 3, the rechargeable battery 2 according to an embodiment may include a case 100, an electrode assembly 200, a first tab member 301, a cap assembly 400, and a first connection member 500.

The case 100 generally forms an exterior of the rechargeable battery 2 and may accommodate the electrode assembly 200.

The case 100 according to an embodiment may include a bottom portion 110, a front portion 120, a rear portion 130, a first side portion 140, and a second side portion 150.

The bottom portion 110 may form a bottom side exterior of the case 100 (see FIG. 3). The bottom portion 110 according to an embodiment may have a rectangular plate shape. The bottom portion 110 may be seated on a bottom surface of the housing body 11.

The front portion 120, the rear portion 130, the first side portion 140, and the second side portion 150 may form an exterior of a peripheral surface of the case 100.

The front portion 120, the rear portion 130, the first side portion 140, and the second side portion 150 according to an embodiment may have a plate shape extending upward from an edge of the bottom portion 110 (see FIG. 3). The front portion 120, the rear portion 130, the first side portion 140, and the second side portion 150 may be disposed to surround an upper space of the bottom portion 110. In an embodiment, the front portion 120, the rear portion 130, the first side portion 140, and the second side portion 150 may be disposed to form a rectangular cross-sectional shape.

The front portion 120 and the rear portion 130 may be disposed to face each other along a longitudinal direction of the housing 10. The front portion 120 and the rear portion 130 may be disposed parallel to each other. Areas of the front portion 120 and the rear portion 130 may be the same.

The first side portion 140 and the second side portion 150 may be disposed to face each other along a width direction of the housing 10. The first side portion 140 and the second side portion 150 may be disposed parallel to each other. Areas of the first side portion 140 and the second side portion 150 may be the same. The areas of the first side portion 140 and the second side portion 150 may be smaller than the areas of the front portion 120 and the rear portion 130.

The case 100 may further include an opening 160. The opening 160 according to an embodiment may be a space surrounded by upper end portions of the front portion 120, the rear portion 130, the first side portion 140, and the second side portion 150. The opening 160 may interconnect an internal space and an external space of the case 100.

Accordingly, the case 100 according to an embodiment may have a shape of a rectangle with an open top.

A first direction described herein may refer to a direction parallel to a Z-axis based on FIG. 3 and a direction from the bottom portion 110 to the opening 160. A second direction may refer to a direction parallel to a Y-axis based on FIG. 3, and a direction from the first side portion 140 to the second side portion 150. A third direction may refer to a direction parallel to an X-axis based on FIG. 3, and a direction from the front portion 120 to the rear portion 130.

The electrode assembly 200 may function as a unit structure that performs charging and discharging operations of power in the rechargeable battery 2. The electrode assembly 200 may be accommodated inside the case 100.

The electrode assembly 200 according to an embodiment may include a first electrode, a second electrode, and a separator disposed between the first electrode and the second electrode. A plurality of first electrodes, separators, and second electrodes may be provided.

Herein, as an example, an electrode assembly having a stacked form in which a plurality of first electrodes, separators, and second electrodes are stacked sequentially along the third direction will be described. However, the electrode assembly is not limited to this form, and may be formed to have a form in which the first electrode, the separator, and the second electrode are stacked and wound clockwise or counterclockwise around a winding axis.

The first electrode may function as either a positive electrode or a negative electrode of the electrode assembly. Herein, the first electrode will be described as an example of the positive electrode of the electrode assembly. However, the first electrode is not limited thereto and may function as the negative electrode of the electrode assembly.

The first electrode according to an embodiment may have a shape of a foil including a metal material, such as aluminum or an aluminum alloy. A type, size, and shape of the first electrode are not particularly limited, as long as the first electrode does not cause a chemical change in the rechargeable battery and is conductive. A cross-sectional shape of the first electrode may have any of various shapes in addition to a rectangular shape.

A plurality of first electrodes may be provided. The plurality of first electrodes may be arranged in the third direction between the front portion 120 and the rear portion 130 of the case 100. A number of first electrodes may be selected depending on a charging capacity of the rechargeable battery 2 and the like.

At least a portion of the first electrode may be coated with a first active material layer. Both, or opposite, surfaces of the first electrode may be coated with the first active material layer or only one surface of the first electrode may be coated with the first active material layer.

In an embodiment, the first electrode functions as the positive electrode, and the first active material layer may include a positive active material.

The positive electrode active material may be a compound capable of reversible intercalation and deintercalation of lithium (a lithiated intercalation compound). In an embodiment, one or more of composite oxides of lithium and a metal selected from cobalt, manganese, nickel, iron, and a combination thereof may be used.

In an example, the positive electrode active material may include at least one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM). Here, 0<x<1, 0<y<1, 0<z<1, and x+y+z=1 may be satisfied.

The positive electrode active material may include only one of lithium-iron-phosphorus oxide (LiFePO₄, LFP), lithium-manganese-iron-phosphorus oxide (LiMnFePO₄, LMFP), and lithium-nickel-cobalt-manganese oxide (LiNixCoyMnzO₂, NCM), and may include any two or all of lithium-iron-phosphorus oxide (LiFePO₄, LFP), lithium-manganese-iron-phosphorus oxide (LiMnFePO₄, LMFP), and lithium-nickel-cobalt-manganese oxide (LiNixCoyMnzO₂, NCM).

The first active material layer may further include a positive electrode conductive material.

The positive electrode conductive material imparts conductivity to the first active material layer and any suitable electrically conductive material that does not cause chemical changes may be used. Examples of the positive electrode conductive material may include a carbon-based material, such as natural graphite, artificial graphite, carbon black, acetylene black, Ketjen black, carbon fibers, carbon nanofibers, and carbon nanotubes, a metal-based material in the form of metal powder or metal fibers containing copper, nickel, aluminum, silver, or the like, a conductive polymer, such as a polyphenylene derivative, or a mixture thereof.

The first active material layer may further include a positive electrode binder.

The positive electrode binder may attach particles constituting the positive electrode active material to each other well and also attach the positive electrode active material to the first electrode well.

An example of the positive electrode binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(metha)acrylonitrile, an ethylene propylene diene copolymer, polyvinylpyridine, chlorosulfonated polyethylene, latex, polyester resin, (metha)acrylic resin, phenolic resin, epoxy resin, polyvinyl alcohol, and a combination thereof.

If the aqueous binder is used as the positive electrode binder, a cellulose-based compound capable of imparting viscosity may be further included. As the cellulose-based compound, one or more of carboxymethyl cellulose, hydroxypropylmethyl cellulose, methyl cellulose, and an alkali metal salt thereof may be mixed and used. In an embodiment, as the alkali metal, Na, K, or Li may be used.

The dry binder may be a polymeric material capable of being fiberized, for example, polytetrafluoroethylene, polyvinylidene fluoride, a polyvinylidene fluoride-hexafluoropropylene copolymer, polyethylene oxide, or a combination thereof.

The first electrode may include a first uncoated portion which is not coated with the first active material layer. The first uncoated portion according to an embodiment may be disposed at an upper end region of the first electrode disposed to face opening inside the case. However, the first uncoated portion is not limited to this shape and, in an embodiment, may be formed across an entire edge region of the first electrode.

The second electrode may function as a remaining one of the positive electrode and the negative electrode of the electrode assembly 200. Herein, an example in which the second electrode is the negative electrode of the electrode assembly will be described. However, the second electrode is not limited thereto and, in an embodiment, may function as the positive electrode of the electrode assembly 200.

A plurality of second electrodes may be provided. The plurality of second electrodes may be arranged in the third direction between the front portion 120 and the rear portion 130 of the case 100. The first electrodes and the second electrodes may be alternately disposed in the third direction. The second electrode may be spaced by an interval (e.g., a predetermined interval) from the first electrode in the third direction.

The second electrode according to an embodiment may be formed to have a shape of a foil including a metallic material, such as copper, a copper alloy, nickel, or a nickel alloy. The second electrode is not particularly limited in a type, size, and shape as long as it does not cause chemical changes in the rechargeable battery and is conductive. A cross-sectional shape of the second electrode may have any of various shapes in addition to a rectangular shape.

At least a portion of the second electrode may be coated with a second active material layer. Both, or opposite, sides of the second electrode may be coated with the second active material layer, or only one surface of the second electrode may be coated with the second active material layer.

In an embodiment, the second electrode functions as the negative electrode, and the second active material layer may include a negative electrode active material.

The negative electrode active material includes a material capable of reversibly intercalating/deintercalating lithium ions, lithium metal, an alloy of lithium and a metal, a material capable of doping and dedoping lithium, or a transition metal oxide.

The material capable of reversibly intercalating/deintercalating lithium ions may be a carbon-based negative electrode active material, for example, crystalline carbon, amorphous carbon, or a combination thereof. Examples of the crystalline carbon may include graphite, such as amorphous, plate-like, flaky, spherical, or fibrous natural graphite or artificial graphite, and examples of the amorphous carbon may include soft carbon or hard carbon, mesophase pitch carbide, calcined coke, and the like.

As the alloy of lithium and a metal, an alloy of lithium and a metal selected from Na, K, Rb, Cs, Fr, Be, Mg, Ca, Sr, Si, Sb, Pb, In, Zn, Ba, Ra, Ge, Al, and Sn may be used.

As the material capable of doping and dedoping lithium, a Si-based negative electrode active material or Sn-based negative electrode active material may be used. The Si-based negative electrode active material may include silicon, a silicon-carbon composite, SiOₓ (0<x≤2), a Si-Q alloy (where Q is selected from alkali metals, alkaline earth metals, group 13 elements, group 14 elements (excluding Si), group 15 elements, group 16 elements, transition metals, rare earth elements, and a combination thereof), or a combination thereof. The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may be in the form of silicon particles and amorphous carbon with which the surface of the silicon particles is coated. For example, the silicon-carbon composite may include a secondary particle (core) in which silicon primary particles are assembled and an amorphous carbon coating layer (shell) located on a surface of the secondary particle. The amorphous carbon may also be located between the silicon primary particles such that, for example, the silicon primary particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles and an amorphous carbon coating layer located on a surface of the core.

The Si-based negative electrode active material or the Sn-based negative electrode active material may be used in combination with the carbon-based negative electrode active material.

The second active material layer may further include a negative electrode conductive material and a negative electrode binder.

The negative electrode conductive material imparts conductivity to the second active material layer, and any suitable electrically conductive material that does not cause chemical changes may be used. Examples of the negative electrode conductive material may include natural graphite, artificial graphite, carbon black, acetylene black, Ketjen black, carbon-based materials, such as carbon fibers, carbon nanofibers, carbon nanotubes, etc., a metal-based material in the form of metal powder or metal fibers containing copper, nickel, aluminum, silver, or the like, a conductive polymer, such as a polyphenylene derivative, or a mixture thereof.

The negative electrode binder may attach particles constituting the negative electrode active material to each other well and also attach the negative electrode active material to the second electrode well.

An example of the negative electrode binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(metha)acrylonitrile, an ethylene propylene diene copolymer, polyvinylpyridine, chlorosulfonated polyethylene, latex, polyester resin, (metha)acrylic resin, phenolic resin, epoxy resin, polyvinyl alcohol, and a combination thereof.

If the aqueous binder is used as the negative electrode binder, a cellulose-based compound capable of imparting viscosity may be further included. As the cellulose-based compound, one or more of carboxymethyl cellulose, hydroxypropylmethyl cellulose, methyl cellulose, and an alkali metal salt thereof may be mixed and used. In an embodiment, as the alkali metal, Na, K, or Li may be used.

The dry binder may be a polymeric material capable of being fiberized, for example, polytetrafluoroethylene, polyvinylidene fluoride, a polyvinylidene fluoride-hexafluoropropylene copolymer, polyethylene oxide, or a combination thereof.

The second electrode may include a second uncoated portion which is not coated with the second active material layer. The second uncoated portion according to an embodiment may be disposed at an upper end region of the second electrode disposed to face the opening 160 inside the case 100. However, the second uncoated portion is not limited to such a shape, and, in an embodiment, may be formed across an entire edge region of the second electrode.

The separator may be disposed between the first electrode and the second electrode. The separator may prevent or substantially prevent a short circuit of the first electrode and the second electrode while allowing lithium ions to move between the first electrode and the second electrode.

In an embodiment, the separator may be disposed to surround an entire surface region of the electrode assembly 200. Accordingly, the separator can prevent or substantially prevent the first electrode and the second electrode from being directly exposed to the outside of the electrode assembly 200.

As the separator, two or more layers of polyethylene, polypropylene, polyvinylidene fluoride, or the like may be used, and a mixed multilayer separator, such as a polyethylene/polypropylene two-layer separator, a polyethylene/polypropylene/polyethylene three-layer separator, a polyethylene/polyethylene/polypropylene three-layer separator, etc. may be used.

The separator may include a porous substrate and a coating layer including an organic material, an inorganic material, or a combination thereof located on one surface or both, or opposite, surfaces of the porous substrate.

The porous substrate may be a polymer film formed of a polymer selected from any of polyolefins, such as polyethylene and polypropylene, polyesters, such as polyethylene terephthalate and polybutylene terephthalate, polyacetal, polyamide, polyimide, polycarbonate, polyether ketone, polyarylether ketone, polyetherimide, polyamideimide, polybenzimidazole, polyether sulfone, polyphenylene oxide, a cyclic olefin copolymer, polyphenylene sulfide, polyethylene naphthalate, glass fiber, and polytetrafluoroethylene (e.g., Teflon), or a copolymer or mixture of two or more thereof.

The organic material may include a polyvinylidene fluoride-based polymer or a (meth)acrylic-based polymer.

The inorganic material may include, but is not limited to, inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof.

The organic material and the inorganic material may be present as a mixture in a single coating layer or may be present in a form in which a coating layer including an organic material and a coating layer including an inorganic material are stacked.

The first tab member 301 may be connected to the first electrode and may protrude outside the electrode assembly 200. As the first electrode is, in an embodiment, a positive electrode, the first tab member 301 may function as a positive electrode tab of the rechargeable battery. However, the first tab member 301 is not limited thereto and may function as a negative electrode tab of the rechargeable battery 2 if the first electrode is a negative electrode.

The cap assembly 400 is coupled to the case 100 and may seal the case 100. The cap assembly 400 may be arranged to face the electrode assembly 200 along the first direction.

The cap assembly 400 according to an embodiment may include a cap plate 410, a first terminal 420, and a second terminal 430.

The cap plate 410 forms a general appearance of the cap assembly 400 and may support the first terminal 420 and the second terminal 430.

The first terminal 420 may protrude outwardly from the cap plate 410. The first terminal 420 may be electrically connected to the first electrode. In an embodiment, the first electrode functions as a positive electrode, and the first terminal 420 may be a positive terminal of the rechargeable battery 2.

The second terminal 430 may protrude outwardly from the cap plate 410 at a position spaced apart from the first terminal 420. The second terminal 430 may be electrically connected to the second electrode. In an embodiment, the second electrode functions as a negative electrode, and the second terminal 430 may be a negative terminal of the rechargeable battery 2.

The cap assembly 400 according to an embodiment may further include a vent hole 440, a vent 450, an electrolyte injection port 460, and an insulating plate 470.

In an embodiment, a first gasket 421 may be installed between the cap plate 410 and the first terminal 420, and a second gasket 431 may be installed between the cap plate 410 and the second terminal 430.

The rechargeable battery according to an embodiment may further include a first connecting member 500 and a second connecting member 600.

The first connecting member 500 may be arranged between the electrode assembly 200 and the cap assembly 400. The first connecting member 500 may be connected to the first terminal 420 and the first tab member 301. The first connecting member 500 may electrically connects the first terminal 420 and the first tab member 301.

The first connecting member 500 according to an embodiment may include a first collector 510 and a first collector plate 520.

The first collector 510 may be connected to a first terminal 420.

The first collector 510 according to an embodiment may include a first body 511 and a first boss 512.

The first body 511 may form a side of an outer surface of the first collector 510 and may support the first boss 512.

The first body 511 according to an embodiment may be arranged between the electrode assembly 200 and the first terminal 420. The first body 511 may be spaced apart from the lower surface of the first terminal 420 by a distance (e.g., a predetermined distance) in the first direction.

The first boss 512 may extend from the first body 511 and be connected to the first terminal 420.

The first current collector plate 520 may be fixed to the first current collector 510 and connected to the first tab member 301.

The first current collector plate 520 according to an embodiment includes a first center plate 521, a first inner plate 522, and a first outer plate 523.

The first center plate 521 forms a central outer surface of the first collector plate 520 and is connected to the first collector 510.

The first center plate 521 according to an embodiment may be arranged between the first body 511 and the electrode assembly 200. The first center plate 521 may be in contact with the lower surface of the first body 511 located on an opposite side of the first boss 512. The first center plate 521 may be fixed to the lower surface of the first body 511 by any of various types of joining methods, such as any of welding, bolting, and adhesion.

In an embodiment, the first center plate 521 has both, or opposite, ends extending from the first body 511 toward the electrode assembly 200. The first center plate 521 may have both, or opposite, ends penetrate the insulating plate 470 and be arranged on the lower side of the insulating plate 470.

The first inner plate 522 may extend from the first collector 510 in the second direction.

The first inner plate 522 according to an embodiment may extend from an end of the first center plate 521 in the second direction. The first inner plate 522 may be arranged to face the first inner tab member 310 in the first direction. The first inner plate 522 may be in contact with the end surface of the first inner tab member 310.

The second connecting member 600 may be arranged between the electrode assembly 200 and the cap assembly 400. The second connecting member 600 can be connected to the second terminal 430 and the second tab member 302.

The second connecting member 600 electrically connects the second terminal 430 and the second tab member. The second connecting member 600 may be formed of a material that conducts electricity. In an embodiment, the second connecting member 600 may be formed of a same material as the second terminal 430.

The second connecting member 600 may include a second current collector 610 and a second current collector plate 620.

The second current collector 610 is connected to the second terminal 430.

The second current collector 610 according to an embodiment includes a second body 611 and a second boss 612.

The second body 611 forms a side of an outer surface of the second collector 610 and supports the second boss 612.

The second body 611 according to an embodiment is placed between the electrode assembly 200 and the second terminal 430. The second body 611 can be spaced apart from the lower surface of the second terminal 430 by a distance (e.g., a predetermined distance) in the first direction.

The second boss 612 may be extended from the second body 611 and connected to the second terminal 430.

The second boss 612 according to an embodiment may have a cylindrical shape extending from the second body 611 in the first direction.

The second collector plate 620 may be fixed to the second collector 610 and connected to the second tab member 302.

The second collector plate 620 according to an embodiment includes a second center plate 621, a second inner plate 622, and a second outer plate 623.

The second center plate 621 forms a central outer surface of the second collector plate 620 and may be connected to the second collector 610.

The second center plate 621 according to an embodiment may be placed between the second body 611 and the electrode assembly 200. The second center plate 621 may be in contact with the lower surface of the second body 611 located on the opposite side of the second boss 612. The second center plate 621 may be fixed to the lower surface of the second body 611 by any of various types of joining methods, such as any of welding, bolting, and bonding.

In an embodiment, the second center plate 621 has both, or opposite, ends extending from the second body 611 toward the electrode assembly 200. The both, or opposite, ends of the second center plate 621 can penetrate the insulating plate 470 and be arranged on the lower side of the insulating plate 470.

The second inner plate 622 can be extended from the second current collector 610 in the opposite direction to the second direction.

The second inner plate 622 according to an embodiment can be extended from an end of the second center plate 621 in an opposite direction to the second direction. The second inner plate 622 can be arranged to face the second inner tab member 330 along the first direction. The second inner plate 622 can come into contact with the end surface of the second inner tab member 330.

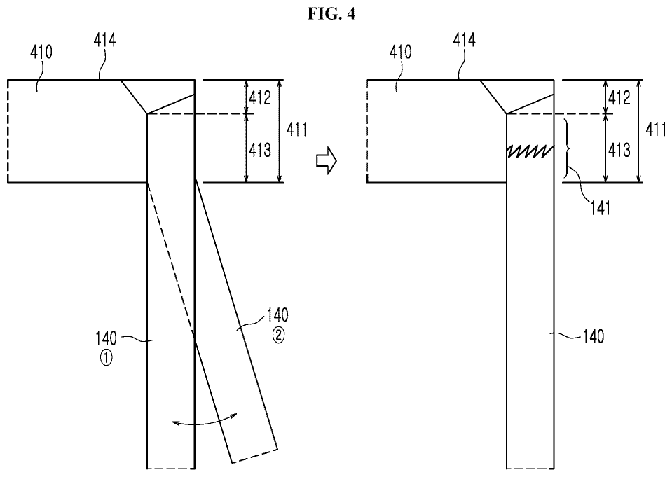

FIG. 4 is an explanatory view of the operation of a first side portion of the case and a cap plate during charging and discharging of the rechargeable battery.

Referring to FIG. 4, the electrode assembly (not illustrated in FIG. 4) may repeat expansion and contraction during charging and discharging. The expansion and contraction of the electrode assembly may change a position of the first side portion 140 of the case with respect to the cap plate 410 by a certain (e.g., predetermined) displacement from \textcircled{1} to \textcircled{2}.

When the cap plate 410 includes a contact region 411 which comes into contact with the first side portion 140, and the contact region 411 includes at least a bonded region 412 between the first side portion 140 and the cap plate 410, the movement of the first side portion of the case becomes free, such that a displacement degree may be increased.

As used herein, a “bonded region” of the cap plate 410 and the first side portion 140 may refer to a region where the cap plate is physically or chemically bonded to the first side portion 140.

As used herein, a “contact region” of the cap plate 410 and the first side portion 140 may refer to a region where the cap plate contacts the first side portion regardless of whether the cap plate and the first side portion are bonded.

The contact region 411 may further include a non-bonded region 413 in addition to the bonded region 412. The non-bonded region 413 may be a region where the cap plate 410 and the first side portion 140 simply come into contact with each other without any physical or chemical bonding. The expansion and contraction of the electrode assembly may cause fractures in the contact region 411, and, in an embodiment, in a first region 141 of the first side portion 140 corresponding to the non-bonded region 413. In particular, if the bonded region is formed by welding and the first side portion is formed of aluminum, the occurrence of fractures may become severe.

In the rechargeable battery 2 according to an embodiment, the cap plate 410 includes the contact region 411 which comes into contact with the first side portion 140, wherein the contact region 411 includes the bonded region 412 and the non-bonded region 413 between the first side portion 140 and the cap plate 410, and an adhesive portion 700 is formed in at least a portion of the first region 141 of the first side portion 140 corresponding to the non-bonded region 413. The adhesive portion may prevent or substantially prevent fractures in the side portion of the case during charging and discharging of the battery.

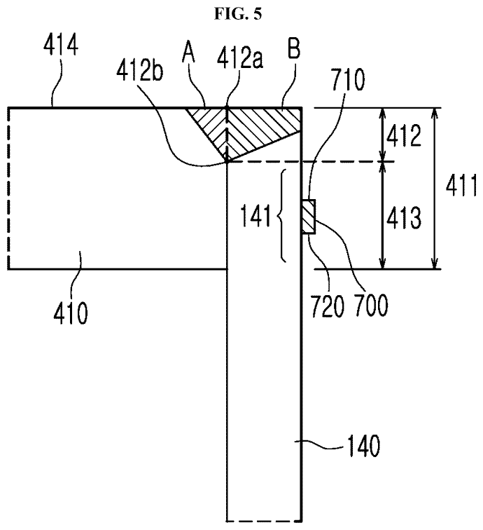

FIG. 5 is an enlarged view illustrating a configuration of the first side portion of the case and the cap plate of a rechargeable battery according to an embodiment of the present invention.

Referring to FIG. 5, the cap plate 410 includes the contact region 411 which comes into contact with the first side portion 140 of the case.

The contact region 411 may be a region where the cap plate 410 comes into contact with the first side portion 140 of the case in a thickness direction of the cap plate 410.

In an embodiment, the contact region 411 may be a side surface of the cap plate 410 in the thickness direction. A shape of the contact region 411 may vary depending on a shape of the side surface of the cap plate 410. The contact region 411 may have a square or a rectangular shape, but the present invention is not limited thereto.

Here, a “contact region” of the cap plate 410 and the first side portion 140 may refer to a region where the cap plate 410 and the first side portion 140 are in contact, regardless of whether the cap plate 410 and the first side portion 140 are bonded.

The cap plate 410 includes the bonded region 412 that is bonded with the first side portion 140.

As used herein, a “bonded region” of the cap plate 410 and the first side portion 140 may refer to a region where the cap plate 410 is physically or chemically bonded to the first side portion 140.

The bonded region 412 may occupy a portion of the contact region 411. In an embodiment, for example, the bonded region 412 may occupy 50% to 90% of the contact region 411 in terms of area percentage. Within this range, the reliability of the battery may be increased by increasing the bonding strength between the cap plate and the first side portion.

The bonded region 412 may be a welded region. The cap plate 410 and the first side portion 140 may be bonded by welding. The bonding of the cap plate 410 and the first side portion 140 by welding may increase the strength of the bonding between the cap plate 410 and the first side portion 140, thereby increasing a degree of freedom of displacement of the first side portion 140 during charging and discharging of the battery.

The bonded region 412 may be included in the contact region 411.

The contact region 411 may include the bonded region 412 and the non-bonded region 413.

The non-bonded region 413 may be a region where the cap plate 410 and the first side portion 140 simply come into contact with each other without physical or chemical bonding. The non-bonded region 413 may increase the degree of freedom of displacement of the first side portion during charging and discharging of the electrode assembly.

The non-bonded region 413 may be continuously formed from the bonded region 412. In an embodiment, the bonded region 412 and the non-bonded region 413 may be formed sequentially from a top surface 414 of the cap plate.

The bonded region 412 may include a first end 412a in the contact region 411 and a second end 412b facing the first end 412a. In an embodiment, the first end 412a may be present at the top surface 414 of the cap plate 410 in the contact region 411 of the cap plate 410.

The first side portion 140 of the case may come into contact with the contact region 411 of the cap plate 410.

In an embodiment, the first side portion 140 of the case may include the first region 141 corresponding to the non-bonded region 413. As used herein, “corresponding” may refer to a projection of the non-bonded region of the cap plate 410, i.e., a portion of the first side portion that is not bonded to a side surface in the thickness direction of the cap plate 410.

A portion of the cap plate 410 and a portion of the first side portion 140 are bonded by a bonded portion A+B. The bonded portion A+B can increase the strength of the battery by bonding a portion of the cap plate and a portion of the first side portion during a battery manufacturing process.

The bonded portion A+B may include the bonded region 412. In an embodiment, the bonded portion A+B may include a first bonded portion A and a second bonded portion B, and the first bonded portion A and the second bonded portion B may share the bonded region 412 with each other.

The first bonded portion A is formed in the cap plate 410 and may bond the cap plate 410 and the first side portion 140 by sharing the bonded region 412. The second bonded portion B is formed in the first side portion 140 and may bond the cap plate 410 and the first side portion 140 by sharing the bonded region 412.

In an embodiment, a cross-sectional area of the first bonded portion A may be smaller than a cross-sectional area of the second bonded portion B. Due to the cross-sectional area of the first bonded portion A being smaller than the cross-sectional area of the second bonded portion B, the bonding strength between the cap plate and the first side portion may be increased, and a possibility of fractures occurring in the first side portion and a possibility of the first side portion being delaminated from the cap plate may be reduced even during charging and discharging of the battery.

For example, the cross-sectional area of the first bonded portion A may be in a range from 10% to 90% of the cross-sectional area of the second bonded portion B, for example, a range from 20% to 80%.

The first bonded portion A and the second bonded portion B may each include a welded region. In an embodiment, the welded region may be formed by conventional laser welding after positioning a case including the cap plate 410 and the first side portion 140.

An adhesive portion 700 is formed in at least a portion of the first region 141.

In an embodiment, the bonded region 412 occupies a portion of the contact region 411, and the displacement of the first side portion 140 during charging and discharging of the battery may be free. However, in the non-bonded region 413 of the contact region 411, the pressure applied to the first side portion 140 during charging and discharging of the battery may be received as is, and, thus, fractures may occur.

Particularly, if the first side portion 140 is made of an aluminum material and the bonded region 412 is a welded region, the aluminum material may be greatly affected by the heat generated during the welding process, which may cause the occurrence of fractures in the non-bonded region 413 to become severe. The adhesive portion 700 may prevent or substantially prevent fractures in the first side portion 140 during charging and discharging of the battery, thereby increasing the life and reliability of the battery.

The adhesive portion 700 may include a first end 710 and a second end 720 facing the first end 710. The first end 710 of the adhesive portion 700 may be adjacent to the top surface 414 of the cap plate 410 with respect to the second end 720 of the adhesive portion 700.

The first end 710 of the adhesive portion 700 may be positioned at a same position or a lower position with respect to the second end 412b of the bonded region 412. In an embodiment, the first end 710 of the adhesive portion 700 is at the same position or a lower position with respect to the second end 412b of the bonded region 412, and the strength of the battery by the bonded region may be improved and the first side portion may be prevented or substantially prevented from being fractured during charging and discharging of the battery by the adhesive portion.

In an embodiment, a separation distance between the first end 710 of the adhesive portion 700 and the second end 412b of the bonded region 412 may be 0 mm to 5 mm, for example, greater than 0 mm and less than or equal to 5 mm, for example, 1 mm to 5 mm. Considering the thickness of the cap plate in the above range, an effect of preventing or substantially preventing fractures in the first side portion can be obtained, and the displacement of the first side portion is free even during charging and discharging of the electrode assembly, such that the first side portion can withstand the charging and discharging of the electrode assembly.

In an embodiment, a thickness of the cap plate 410 may be smaller than a width between the first end 710 of the adhesive portion 700 and the second end 720 of the adhesive portion 700. In this case, fractures in the first side portion by forming the adhesive portion on the first side portion may be prevented or substantially prevented.

In an embodiment, for example, the thickness of the cap plate 410 may be in a range from 20% to 50% of the width between the first end 710 of the adhesive portion 700 and the second end 720 of the adhesive portion 700.

In an embodiment, the thickness of the cap plate 410 may be in a range from 1 mm to 5 mm, for example, in a range from 1.5 mm to 3 mm. In an embodiment, the width between the first end of the adhesive portion and the second end of the adhesive portion may be in a range from 1 mm to 25 mm, for example, in a range from 5 mm to 20 mm.

In an embodiment, a width between the first end 412a of the bonded region 412 and the second end 412b of the bonded region 412 may be smaller than the width between the first end 710 of the adhesive portion 700 and the second end 720 of the adhesive portion 700.

In an embodiment, for example, the width between the first end 412a of the bonded region 412 and the second end 412b of the bonded region 412 may be in a range from 20% to 50% of the width between the first end 710 of the adhesive portion 700 and the second end 720 of the adhesive portion 700.

In an embodiment, the width between the first end 412a of the bonded region 412 and the second end 412b of the bonded region 412 may be in a range from 0.1 mm to 5 mm, for example, in a range from 0.5 mm to 4 mm. In an embodiment, the width between the first end of the adhesive portion and the second end of the adhesive portion may be in a range from 1 mm to 25 mm, for example, in a range from 5 mm to 20 mm.

The thickness of the adhesive portion 700 may be the same as or different from the thickness of the first side portion 140. For example, the thickness of the adhesive portion 700 may be smaller than or larger than the thickness of the first side portion 140.

In an embodiment, the thickness of the first side portion 140 may be in a range from 0.1 mm to 2 mm, for example, in a range from 0.3 mm to 1 mm. In an embodiment, the thickness of the adhesive portion 700 may be in a range from 0.1 mm to 5 mm, for example, in a range from 0.1 mm to 3 mm.

The adhesive portion 700 may be formed of a composition including an adhesive resin. The adhesive resin may not be particularly limited as long as the adhesive resin has a melting point capable of withstanding a temperature inside the battery when the battery is operated. For example, the adhesive resin may include one or more of (meth)acrylic-based resin, silicone-based resin, epoxy-based resin, urethane-based resin, and the like, but is not limited thereto.

The adhesive portion may further include an inorganic material in addition to the adhesive resin. The inorganic material may be used without limitation as long as it is an inorganic material with insulating properties.

The adhesive portion may be a single-layer adhesive tape. In an embodiment, in the single-layer adhesive tape, the adhesive portion may be formed only in the first region of the first side portion. However, the adhesive portion may be formed in a region other than the first region of the first side portion.

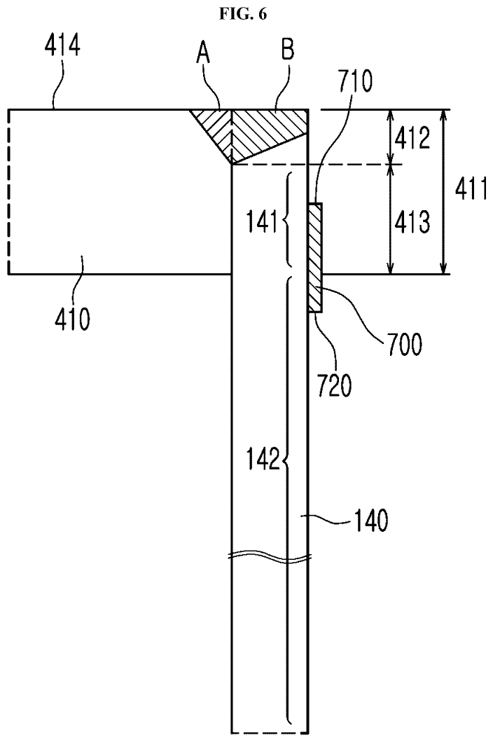

FIG. 6 is an enlarged view illustrating a configuration of a first side portion of a case and a cap plate of a rechargeable battery according to another embodiment of the present invention.

Referring to FIG. 6, the first side portion 140 may further include a first region 141 corresponding to the non-bonded region and a second region 142 that does not correspond to the non-bonded region.

The second region 142 may be a region of the first side portion 140 corresponding to the electrode assembly. A ratio of the first and second regions and each length thereof may be adjusted according to the width of the electrode assembly.

The adhesive portion 700 may be formed to extend to a portion of the second region 142. In an embodiment, the second adhesive portion 700 extends to a portion of the second region 142, and fractures in the region of the first side portion where the cap plate does not come into contact with the first side portion may be prevented or substantially prevented.

As illustrated in FIG. 6, the adhesive portion may be a single-layer adhesive tape. However, the adhesive portion may be a plurality of adhesive layers spaced apart from each other. In an embodiment, the adhesive portion may include a plurality of adhesive tapes spaced apart from each other.

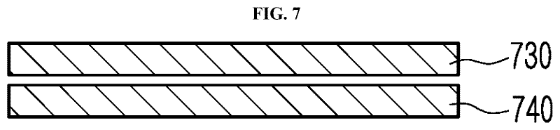

FIG. 7 is an explanatory view of an attachment shape of an adhesive portion on a first side portion of the rechargeable battery according to another embodiment of the present invention.

Referring to FIG. 7, the adhesive portion may include two adhesive tapes spaced apart from each other. The adhesive portion may include a first adhesive tape 730 and a second adhesive tape 740, and the first adhesive tape 730 and the second adhesive tape 740 may be spaced apart from each other.

The first adhesive tape 730 and the second adhesive tape 740 may be spaced apart from each other in the first direction. A spacing between the first adhesive tape and the second adhesive tape may be adjusted in consideration of a length of the first side portion, a thickness of the first side portion, and a thickness of the cap plate.

FIG. 7 illustrates a battery including two adhesive tapes spaced apart from each other. However, the present invention is not limited thereto, and the adhesive portion may include more than two or three or more adhesive tapes spaced apart from each other. Further, the spacing between the adhesive tapes may also be the same or different.

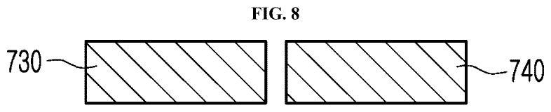

FIG. 8 is an explanatory view of an attachment shape of an adhesive portion on a first side portion of the rechargeable battery according to another embodiment of the present invention.

Referring to FIG. 8, the adhesive portion may include two adhesive tapes spaced apart from each other. The adhesive portion may include a first adhesive tape 730 and a second adhesive tape 740, and the first adhesive tape 730 and the second adhesive tape 740 may be spaced apart from each other.

The first adhesive tape 730 and the second adhesive tape 740 may be spaced apart from each other in the second direction. A spacing between the first adhesive tape and the second adhesive tape may be adjusted in consideration of a length of the first side portion, a thickness of the first side portion, and a thickness of the cap plate.

FIG. 8 illustrates a battery including two adhesive tapes spaced apart from each other. However, the present invention is not limited thereto, and the adhesive portion may include more than two or three or more adhesive tapes spaced apart from each other. Further, the spacing between the adhesive tapes may also be the same or different.

FIGS. 5 to 8 each illustrate batteries in which the adhesive portions are formed on the first side portion of the case. However, the adhesive portion may also be formed on the second side portion facing the first side portion of the case.

According to embodiments of the present invention, fractures in a side portion of a case during charging and discharging of a battery can be prevented or substantially prevented, thereby increasing the reliability of a rechargeable battery.

However, aspects and effects obtainable through the present invention are not limited to the above-described aspects and effects, and other aspects and technical effects that are not mentioned will be clearly understood by those skilled in the art from the description of the invention.

The present invention has been described with reference to some embodiments illustrated in the drawings, which are merely examples, and those having ordinary skill in the art will understand that various modifications and equivalent other embodiments are possible.

Therefore, the scope of technical protection of the invention should be defined by the claims.

What is claimed is:

1. A rechargeable battery comprising:
a case comprising a first side portion;
an electrode assembly accommodated in the case; and
a cap plate facing the electrode assembly in a first direction, and comprising a contact region in contact with the first side portion,
wherein the contact region comprises a bonded region and a non-bonded region between the first side portion and the cap plate, and
an adhesive portion is in at least a portion of a first region of the first side portion corresponding to the non-bonded region.

2. The rechargeable battery as claimed in claim 1, wherein the adhesive portion is only in the first region.

3. The rechargeable battery as claimed in claim 1, wherein the first side portion further comprises a second region that does not correspond to the contact region and is continuous to the first region, and
the adhesive portion extends to the second region.

4. The rechargeable battery as claimed in claim 1, wherein the bonded region comprises a first end and a second end facing the first end in the contact region, and
the adhesive portion comprises a first end and a second end facing the first end.

5. The rechargeable battery as claimed in claim 4, wherein the first end of the adhesive portion is at a same position or a lower position relative to the second end of the bonded region.

6. The rechargeable battery as claimed in claim 5, wherein a separation distance between the first end of the adhesive portion and the second end of the bonded region is from 0 mm to 5 mm.

7. The rechargeable battery as claimed in claim 4, wherein a thickness of the cap plate is less than a width between the first end of the adhesive portion and the second end of the adhesive portion.

8. The rechargeable battery as claimed in claim 4, wherein a width between the first end and the second end of the bonded region is less than a width between the first end and the second end of the adhesive portion.

9. The rechargeable battery as claimed in claim 4, wherein a thickness of the adhesive portion is less than a thickness of the first side portion.

10. The rechargeable battery as claimed in claim 1, wherein a portion of the cap plate and a portion of the first side portion are bonded by a bonded portion, and
the bonded portion comprises the bonded region.

11. The rechargeable battery as claimed in claim 10, wherein the bonded portion comprises a first bonded portion comprising the bonded region and is located in the cap plate, and
a second bonded portion which comprises the bonded region and is located in the first side portion.

12. The rechargeable battery as claimed in claim 11, wherein a cross-sectional area of the first bonded portion is smaller than a cross-sectional area of the second bonded portion.

13. The rechargeable battery as claimed in claim 11, wherein the first bonded portion and the second bonded portion comprise a welded region.

14. The rechargeable battery as claimed in claim 13, wherein the first side portion comprises aluminum.

15. The rechargeable battery as claimed in claim 4, wherein a thickness of the cap plate is from 1.5 mm to 3 mm,
a width between the first end and the second end of the bonded region is from 0.5 mm to 4 mm,
a width between the first end and the second end of the adhesive portion is from mm to 20 mm,
a thickness of the first side portion is from 0.3 mm to 1 mm, and
a thickness of the adhesive portion is from 0.1 mm to 3 mm.

16. The rechargeable battery as claimed in claim 1, wherein the adhesive portion comprises a single adhesive layer or a plurality of adhesive layers spaced apart from each other.

17. The rechargeable battery as claimed in claim 1, wherein the case comprises a second side portion facing the first side portion, and
the adhesive portion is on the second side portion.

18. A battery pack comprising the rechargeable battery of claim 1.
